(19) United States
(12) Patent Application Publication
(10) Pub. No.: US 2014/0300854 A1
(43) Pub. Date: Oct. 9, 2014

(54) EYEGLASSES WITH LENS SECURING MECHANISM FOR FACILITATING REMOVABLE LENSES

(71) Applicant: Mountain Shades, Inc., Wheat Ridge, CO (US)

(72) Inventor: THOMAS DEAN FOX, LAKEWOOD, CO (US)

(73) Assignee: Mountain Shades, Inc., Wheat Ridge, CO (US)

(21) Appl. No.: 14/247,917

(22) Filed: Apr. 8, 2014

Related U.S. Application Data
(60) Provisional application No. 61/809,803, filed on Apr. 8, 2013.

(51) Int. Cl. G02C 1/08; G02C 13/00; G02C 7/10

(52) U.S. Cl. CPC G02C 1/08; G02C 7/10; G02C 13/001
USPC 351/47; 351/90; 351/178; 351/96

(57) ABSTRACT

Eyewear is provided, namely, sunglasses with an integral securing mechanism that enables the lenses to be removed and replaced as necessary. Each of the lenses may retained within the frame of the eyewear/sunglass device as by corresponding channels or recesses formed on each corresponding side of the sunglass frame. For separate lenses, a securing mechanism is provided for securing each of the lenses. In a mono lens configuration, a single securing mechanism may be used to secure both lenses. A securing mechanism is placed in a locked position to hold the lens(es) in place during use. The securing mechanism is placed in an unlocked position by sliding or shifting the securing mechanism, enabling removal of the lens(es). Various constructions can be adopted for maintaining the securing mechanism in the locked position, such as by frictional force, magnetic force, or combinations thereof.

### CROSS REFERENCE TO RELATED APPLICATIONS

The present application claims the benefit of U.S. Provisional Application Ser. No. 61/809,803, filed Apr. 8, 2013, the entirety of which is incorporated herein by this reference.

### FIELD OF THE INVENTION

The present invention relates to eyewear with removable lenses facilitated by a securing mechanism that enables the lenses to be secured during use, and to be released in order to remove and replace the lenses.

### BACKGROUND OF THE INVENTION

While embodiments described herein are in the context of sunglasses, it should be appreciated that the concepts and structures described herein apply equally to all types of optical eyewear, not just sunglasses. Reference to sunglasses is illustrative and is not intended to be limiting.

Sunglasses are worn by an increasing number of people. The surge in the wear of sunglasses is due to many factors, including awareness for the need to protect the eyes from damaging sunlight, safety concerns, and also fashion reasons. Accordingly, there has been a proliferation of styles of sunglasses and types of lenses made available to the consuming public.

One substantial factor in the decision to purchase and wear sunglasses is the cost associated with purchasing a pair of sunglasses that fit the consumer's particular needs. Sunglasses used for sporting events may require different functional attributes compared to sunglasses used for driving, and sporting and driving sunglasses may have yet further functional requirements different than sunglasses used for casual wear. Accordingly, a consumer may own multiple pairs of sunglasses that adds to the cost of maintaining sunglasses.

It is also known that sunglasses become damaged from wear over time. The traditional solution for alleviating this problem is to simply purchase a new pair of sunglasses.

Therefore, there is a need to address the cost associated with a consumer's need for multiple sunglasses. Further, there is a need to provide a consumer with greater flexibility in terms of the type of lenses available for use based upon the wide variance in reasons why a consumer needs sunglasses. Yet further, there is a need to provide a consumer with a sunglasses construction that is robust, yet may accommodate multiple types of lenses to help alleviate the costs associated with having to own multiple pairs of sunglasses.

### SUMMARY OF THE INVENTION

A sunglasses device is provided with an integral securing mechanism that enables the lenses to be removed and replaced as necessary. Each of the lenses may be retained within the frame of the eyewear/sunglasses device as by corresponding retaining channels or recesses formed on each corresponding side of the sunglass frame. For separate lenses, a securing mechanism is provided for securing each of the lenses. In a mono lens configuration, a single securing mechanism may be used to secure both lenses.

The securing mechanism is placed in a locked position to hold the lens(es) in place during use. The securing mechanism is placed in an unlocked position by sliding or shifting the securing mechanism, enabling removal of the lens(es). Various constructions can be adopted for maintaining the securing mechanism in the locked position, such as by frictional force, magnetic force, or combinations thereof.

In one preferred embodiment of the invention adapted for use with separate lenses, the sunglasses include a pair of securing mechanisms mounted on the respective end pieces of the sunglasses frame. Each securing mechanism is movable between the locked and unlocked positions. More specifically, a securing mechanism is slid or translated toward a facing surface of the adjacent lens to place the securing mechanism in the locked position. The securing mechanism is slid or translated away from the lens for placement of the mechanism in the unlocked position that allows the lens to be removed from within the retaining groove(s) of the frame.

Further in accordance with this first preferred embodiment, the securing mechanism is mounted to the corresponding end piece in which the securing mechanism may be moved in a linear, sliding fashion to place the securing mechanism in either the locked or unlocked position. A slot or opening is formed in the end piece, and the securing mechanism is slidable within the slot/opening. Movement of the securing mechanism towards the lens allows the securing mechanism to be placed in the locked position by the mechanism engaging a feature on the lens, while movement of the securing mechanism away from the lens disengages the securing mechanism from the lens for placement in the unlocked position, thereby facilitating removal of the lens.

In one particular aspect of the first preferred embodiment, the securing mechanism may be provided in the form of a slidable tab that is mounted within the slot of the end piece. The securing mechanism may include a spring-loaded catch that is used to hold the lens in place by movement of the securing mechanism so that the catch engages a protruding hook or extension formed on the exterior edge of the lens that faces the securing mechanism. A retaining spring can be used to urge the securing mechanism to a normally locked or engaged position. Therefore, some amount of force is required to move the securing mechanism to the unlocked position, thereby ensuring the lens does not become inadvertently dislodged from its aligned and mounted position within the frame.

In another aspect of the invention, the securing mechanism may incorporate other means to engage and hold the lens. Accordingly, in another preferred embodiment, the securing mechanism and the facing surface of the corresponding lens may incorporate a tongue and groove type connection in order to hold the lens in the place during use.

In yet another preferred embodiment, one end the securing mechanism may be inserted within a complementary shaped gap in the facing surface of the lens in order to secure the lens.

In yet another embodiment, the securing mechanism slides within a slot formed in the end piece of the ear stem and forms a channel or groove to engage a peripheral edge of the lens. The securing mechanism is shaped such that it may only be moved from a locked position to an unlocked position when the temple or ear stem is in a folded or closed state. In addition, movement of the ear stem to an open or unfolded state will cause the securing mechanism to move to a locked position.

In yet another preferred embodiment, the securing mechanism may incorporate the use of magnets in order to secure the lens as opposed to a mechanical engagement between the securing mechanism in the lens, or a combination of both mechanical engagement and use of magnets may be used. For the use of magnets according to a preferred embodiment of the invention, the securing mechanism may include a first magnet mounted to a surface of the mechanism. When the mechanism is moved to the locked position, the first magnet is placed into close proximity or contact with a second magnet mounted to the facing edge or surface of the lens. The force of the magnets therefore provides a means to hold the lens in place.

The securing mechanism can be selectively shaped and sized so that the securing mechanism aesthetically matches the style of the sunglasses. Further, the securing mechanism may be selectively mounted to different portions of the corresponding end piece. For example, the securing mechanism may be mounted along an upper or lower portion of the end piece, or may be more centrally located along the end piece.

In another embodiment of the invention, instead of using a pair of securing mechanisms, a single securing mechanism can be used with a mono-lens configuration. A mono-lens configuration is one in which the pair of lenses is connected to one another by a bridge piece, thereby resulting in the lenses being a single unit. Accordingly, one securing mechanism can be used to engage one of the lenses, while the other lens may be secured by features formed on the other lens, such as sufficient numbers and spacing of extensions or protuberances received within corresponding retaining channels or recesses of the sunglass frame.

The construction of the securing mechanism is especially adapted to enable a user to quickly remove a lens, and to replace the removed lens without the need for tools. The capability to remove and replace lenses for sunglasses allows a consumer to use both prescription and nonprescription lenses within the same sunglass frame design. Further, the invention may be adapted for use in full frame designs and “rimless” frame designs, that is, a rim/frame design in which the lower portion of the frame has been removed and the lower portion of the lens is exposed.

Considering the above features and characteristics of the invention, it can therefore be considered in one aspect sunglasses with removable lenses, comprising: (i) a sunglasses frame including a pair of sunglass frame members for holding respective lenses, a bridge interconnecting the frame members, each of the frame members including respective frame end pieces, and a pair of temples or ear stems hingedly connected to corresponding end pieces; and (ii) a securing mechanism secured to one of the end pieces, said securing mechanism including a portion thereof for engaging a facing surface of a corresponding lens, and said securing mechanism being slidable between a locked position for holding the lens against the frame, and an unlocked position in which the securing mechanism is moved away from the facing surface of the lens.

In another aspect of the invention, it may also be considered a securing mechanism especially adapted for use with sunglasses in order to secure lenses of the sunglasses to a frame of the sunglasses, said mechanism comprising: (i) a body secured to an end piece of the frame, said body including a portion thereof for engaging a facing surface of a corresponding lens, and said securing mechanism being slidable between a locked position for holding the lens against the frame, and an unlocked position in which the securing mechanism is moved away from the facing surface of the lens; and (ii) an element formed on said body for holding the body against the lens, said element including at least one of a frictional or positional engaging member for engaging the lens, or a magnetic member for magnetically engaging the lens.

In yet another aspect of the invention, it may also be considered a method of removing and replacing lenses in eyeglasses such as sunglasses, the method comprising:

(1) providing:

(i) a frame including a pair of frame members for holding respective lenses, (ii) a bridge interconnecting the frame members, each of the frame members including respective frame end pieces, (iii) a pair of temples hingedly connected to corresponding end pieces, (iv) a securing mechanism secured to one of the end pieces, said securing mechanism including a portion thereof for engaging a facing surface of a corresponding lens, said securing mechanism being slidable between a locked position for holding the lens against the frame, and an unlocked position in which the securing mechanism is moved away from the facing surface of the lens;

(2) grasping the securing mechanism and sliding the mechanism from the locked to the unlocked position;

(3) removing the lens from the frame;

(4) obtaining a replacement lens and placing the lens in engagement with features on the frame for retaining the replacement lens; and

(5) grasping the securing mechanism and sliding the mechanism from the unlocked to the locked position in order to secure the replacement lens in the frame.

Other features and advantages of the invention will become apparent with a review of the following detailed description, taken in conjunction with the drawings.

### BRIEF DESCRIPTION OF THE DRAWINGS

FIG. 1 is a fragmentary front view of sunglasses showing a securing mechanism mounted to an end piece of the sunglasses;

FIG. 2A is an enlarged front view of the securing mechanism of FIG. 1;

FIG. 2B is an enlarged vertical cross-sectional view of the securing mechanism of FIG. 1, illustrating components of the securing mechanism;

FIG. 2C is an enlarged rear view of the securing mechanism of FIG. 1;

FIG. 2D is an enlarged rear perspective view of the securing mechanism of FIG. 1;

FIG. 2E is an enlarged rear exploded perspective view of the securing mechanism of FIG. 1;

FIG. 3 is a fragmentary front view of sunglasses showing a securing mechanism in another preferred embodiment of the invention;

FIG. 4A is an enlarged front view of the securing mechanism of FIG. 3;

FIG. 4B is an enlarged rear view of the securing mechanism of FIG. 3, showing the securing mechanism engaged with the facing surface of the corresponding lens;

FIG. 4C is an end view of the securing mechanism of FIG. 3;

FIG. 4D is an enlarged rear perspective view of the securing mechanism of FIG. 3;

FIG. 4E is an enlarged front perspective view of the securing mechanism of FIG. 3;

FIG. 5 is a fragmentary front view of sunglasses showing a securing mechanism in yet another preferred embodiment of the invention;

FIG. 5A is an enlarged fragmentary view of FIG. 5 showing the portion of the end piece to which the securing mechanism is mounted;

FIG. 6A is an enlarged front view of the securing mechanism of FIG. 5;

FIG. 6B is a an enlarged plan view of the securing mechanism of FIG. 5;

FIG. 6C is an enlarged rear perspective view of the securing mechanism of FIG. 5;

FIG. 6D is an exploded enlarged rear perspective view of the securing mechanism of FIG. 5;

FIG. 7A is a fragmentary front view of sunglasses with the lens removed, and showing a securing mechanism in yet another preferred embodiment of the invention;

FIG. 7B is a plan view of the lens of FIG. 7A;

FIG. 8A is an enlarged front view of the securing mechanism of FIG. 7A;

FIG. 8B is an enlarged rear view of the securing mechanism of FIG. 7A;

FIG. 8C is an end view of the securing mechanism of FIG. 7A taken along line C-C of FIG. 7A, illustrating the securing mechanism mounted within a slot of the end piece;

FIG. 8D is a greatly enlarged perspective view of the securing mechanism of FIG. 7A;

FIG. 8E is a greatly enlarged exploded perspective view of the securing mechanism of FIG. 7A;

FIG. 9A is an exterior perspective view of a further embodiment of a securing mechanism;

FIG. 9B is an interior perspective view of the securing mechanism of FIG. 9A;

FIG. 10 is a top partially exploded view of the securing mechanism of FIG. 9A;

FIG. 11A is an enlarged interior perspective view of the end piece of the frame of FIG. 9A with the lens and securing mechanism removed;

FIG. 11B is an enlarged interior perspective view of the end piece of the frame of FIG. 9A with the lens removed and the rear securing mechanism tab removed, the securing mechanism in an unlocked position and the lens removed;

FIG. 12A is an enlarged exterior perspective view of the frame depicted in FIG. 9A with the temple in a closed position, the securing mechanism in an unlocked position and the lens removed from the frame;

FIG. 12B is an enlarged exterior perspective view of an end piece of the frame shown in FIG. 9A with the temple in a folded position and the securing mechanism in an unlocked position;

FIG. 12C is an enlarged exterior perspective view of an end piece of the frame shown in FIG. 9A with the temple in a folded position, the securing mechanism in an unlocked position and the lens is removed;

FIG. 13A is a top perspective view of the securing mechanism and a lens of the embodiment of FIG. 9A in an unlocked state;

FIG. 13B is a top perspective view of the securing mechanism and lens of FIG. 9A in a locked state.

### DETAILED DESCRIPTION

Referring to FIG. 1, the invention is illustrated in a first embodiment in which a securing mechanism 30 is used to releasably secure a lens 22 within eyeglasses 10, such as sunglasses. FIG. 1 is intended to illustrate a common construction for sunglasses 10, in which a pair of lenses 22 are held within respective frame portions of the sunglasses 10. The sunglasses 10 are more particularly shown as including a frame 12 that is used to secure designated portions of the lens 22. The sunglasses further include other known components, including a bridge 14, an end piece 18, and a temple 16 that is interconnected to the frame/end piece by a hinge 20. The particular construction for the frame 12 may include a full frame design as shown in which the frame 12 supports most of the circumference of the lens 22. Alternatively, the frame 12 could be “rimless” in which the lower edge or portion 13 of the frame is removed, and the lower edge of the lens 22 being exposed.

In accordance with the present invention, it is also contemplated that the lens 22 may be of a desired construction such that the lens is easily removed and replaced within the corresponding sunglasses frame 12. Accordingly, FIG. 1 illustrates the lens 22 with two extensions or protuberances 23 located at the upper outside corners of the lens. These extensions 23 fit within corresponding retaining grooves or channels (not shown) formed within the frame 12. These two points of attachment at the location of the extensions 23 combined with engagement of the lens at the securing mechanism 30 provides a robust connection between the lens and the frame 12. Although FIG. 1 illustrates two extensions 23, it is also contemplated that the lens can be configured with additional extensions 23 for placement within corresponding grooves or channels of the frame; or the frame 12 itself could include another arrangement in terms of one or more channels for receiving other designated portions of the lens 22 in order to hold it into place.

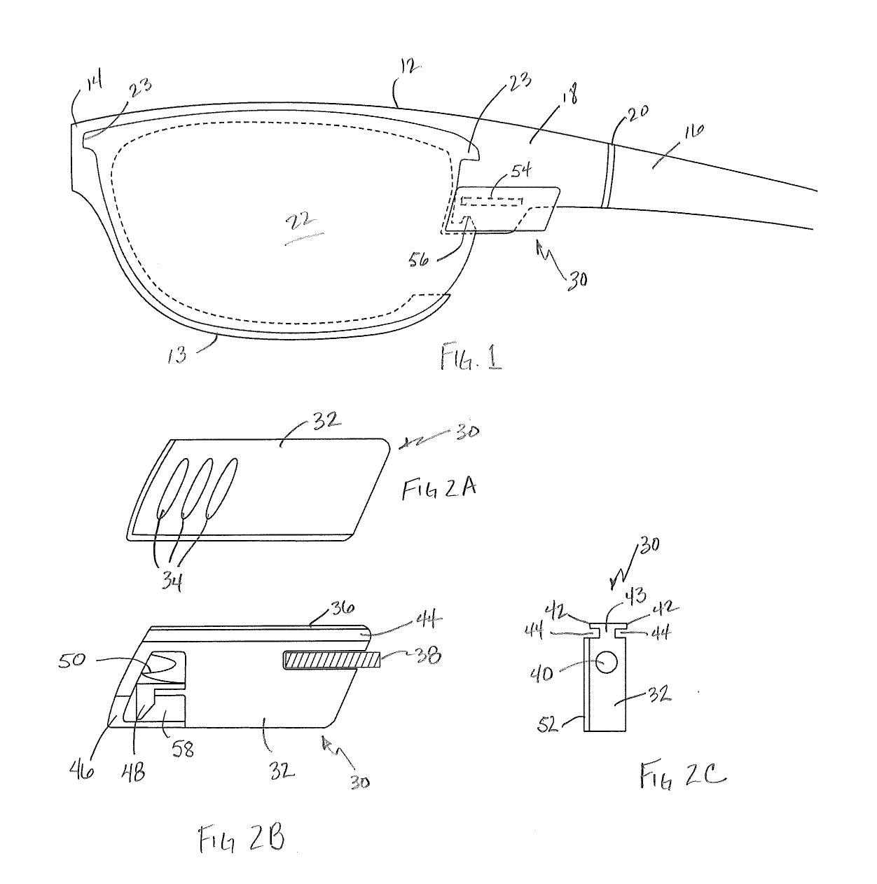

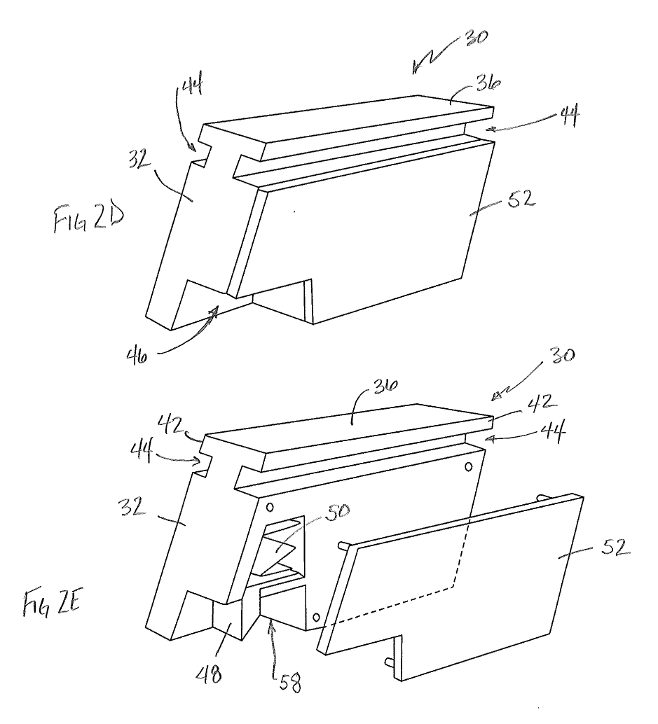

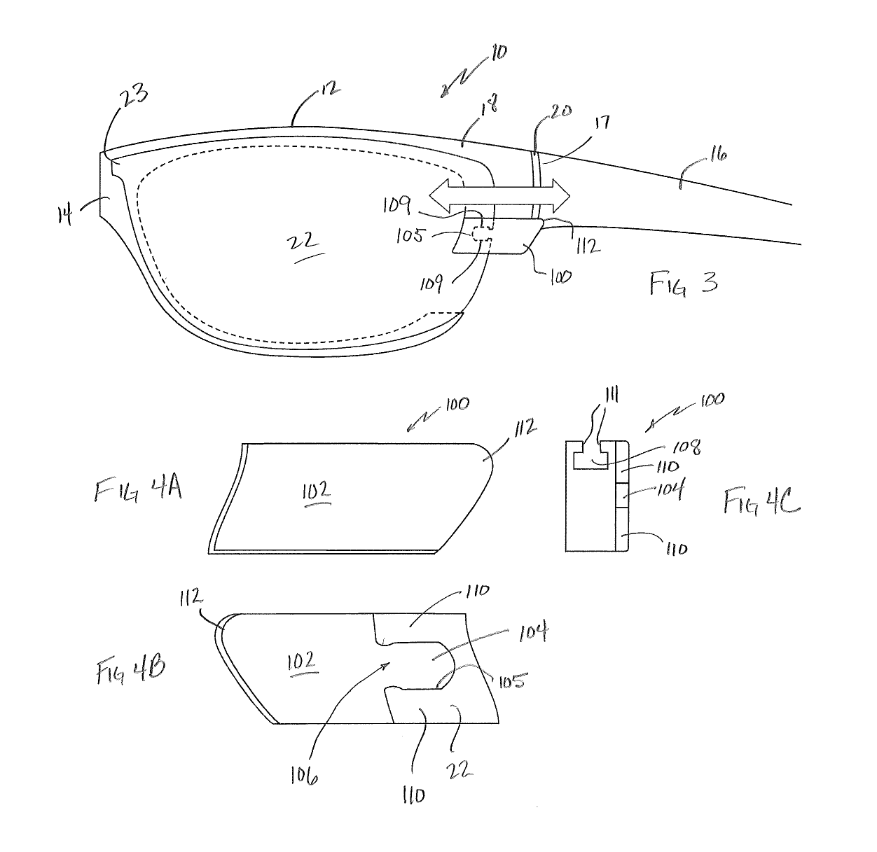

The securing mechanism is mounted to the end piece 18, such as by a slot or opening 54 formed in the end piece 18. The securing mechanism 30 includes structure for engaging the slot 54, enabling the securing mechanism to be slid or translated between a locked and unlocked position. Referring also to FIGS. 2A-2C, details are shown for the securing mechanism. The front surface or face of the securing mechanism 30 includes features that assist a user in sliding the securing mechanism, such as grips or grooves 34 formed on the body 32 of the mechanism 30. The structure provided for sliding the mechanism 30 is shown as a mounting rail 36, which is fitted within the slot 54. As shown, the mounting rail 36 may include a flange 42 attached to the body 32 of the mechanism 30 by an interconnecting web 43. Accordingly, a pair of opposing recesses 44 is formed on opposite sides of the web 43 as best shown in FIG. 2C. The slot 54 is located on the end piece 18 such that the lower edge portion of the end piece 18 resides within the recesses 44, and the body of the end piece 32 extend below the end piece 18. Referring to FIG. 2B, the mechanism 30 may further include a catch 48 that engages a hook or protrusion 56 on the facing surface of the lens 22, such that when the mechanism 30 is slid to a locked position (toward the left according to the orientation of FIG. 1) the catch 48 resides in the gap adjacent the protrusion 56 to therefore hold and locked the lens in place. Also referring to FIGS. 2D and 2E, the catch 48 is disposed within an undercut 46, and the hook or protrusion 56 of the lens 22 resides within the gap 58 when the mechanism 30 is slid to the locked position. The catch 48 may be tensioned as by a spring 50. The spring 50 resides within a cavity formed above the catch 48. In order to urge the mechanism 30 to a normally closed or locked position against the lens, a retaining spring 38 can be used (FIG. 2B), which is mounted within a rear opening 40 formed in the body 32 of the mechanism 30. One end of the spring 38 is inserted within the opening 40, and the opposite end protrudes beyond the body 32 and is placed in contact with the abutting surface of the end piece 18 within the slot 54. As also shown in FIG. 2E, the mechanism 30 may include a removable panel 52 to ease assembly of the components to include installing the catch 48 and spring 50.

In order to remove the lens 22, a user grasps the mechanism 30 and slides it towards the right, such that the catch 48 is removed from engagement with the hook 56. The catch 48 has a chamfered edge (FIG. 2E), which allows it to be easily slid over the top edge of the hook 56, assuming adequate force is applied against the mechanism 30. The user holds the mechanism 30 in the unlocked position, and then rotates the lens 22 away from the frame, resulting in the extensions 23 being separated from their corresponding grooves in the frame 12. The user may then replace the removed lens with another lens by simply aligning the new lens with the frame 12, placing the one or more extensions 23 within their corresponding grooves in the frame, and releasing the mechanism 30 allowing it to slide towards the left, thereby engaging the mechanism with the newly replaced lens.

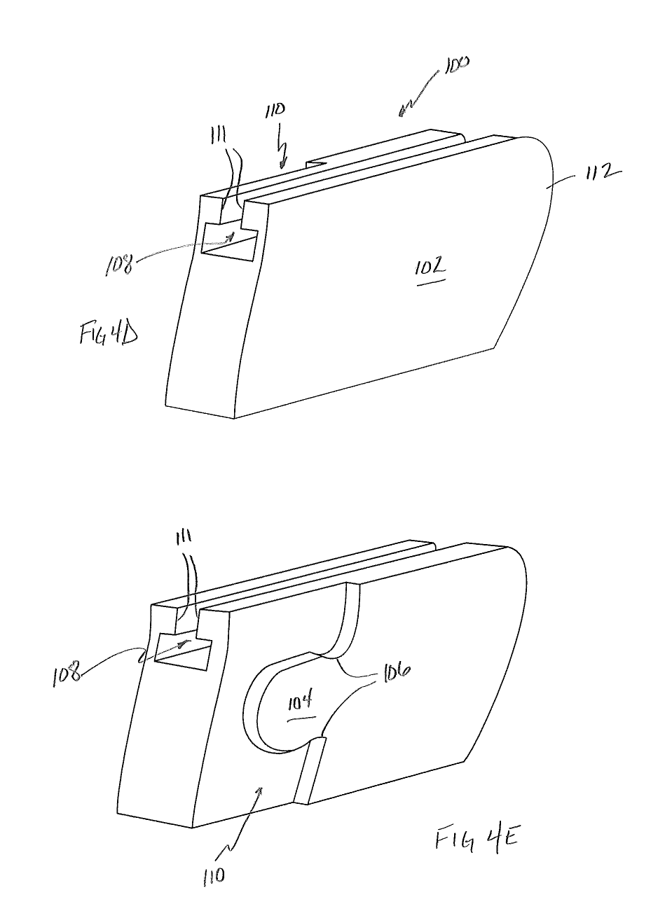

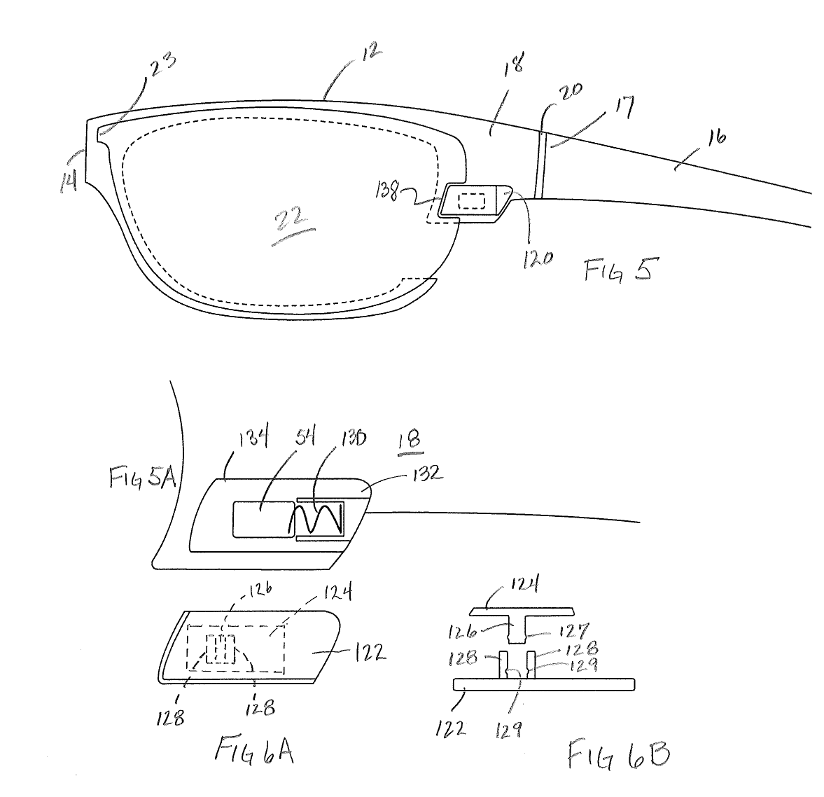

Referring to FIG. 3, another embodiment is illustrated with respect to a different form of the securing mechanism, shown as a securing mechanism 100. In this embodiment, the manner in which the securing mechanism locks or engages the lens is by a friction fit between the securing mechanism and the facing surface of the lens 22. Referring to FIGS. 4A-4C, the securing mechanism 100 is shown as including a body 102 and a protruding tongue or extension 104 that fits within a corresponding shaped groove 105 formed on the facing surface 22 of the lens. Referring more specifically to FIG. 4B, the tongue 104 has a smaller neck 106 such that in order to insert the tongue 104 within the groove 105, the opposing edges 109 of the groove 105 must be slightly spread in order to receive the tongue 104.

Referring to FIG. 4C-4E, the mechanism 100 may be mounted to the end piece 18 in a reverse arrangement as compared to the first embodiment. More specifically, the securing mechanism 100 includes a gap 108, and an opposing pair of flanges 111 extend toward one another, thereby forming a narrower area within the gap 108 directly between the flanges 111. The flanges 111 are mounted within the slot 54 of the end piece 18, thereby allowing the mechanism 100 to slide within the slot 54. The lower edge of the end piece 18 is retained within the gap 108. FIG. 4E also illustrates a recess 110 formed on the rear surface of the body 102 which is adapted to receive the lens 22, thereby facilitating the mating relationship of the groove 105 of the lens 22 and the tongue 104.

In order to remove the lens for the embodiment shown in FIG. 3, the user grasps the mechanism 100, and applies enough force so that the tongue 104 is removed from within the groove 105. The lens 22 is removed, and replaced with another lens. The user then slides the mechanism 100 to the left with enough force applied to place the tongue 104 back within the groove 105. In order to provide a mechanical assist for placing the securing mechanism in the locked position, it is also contemplated that the orientation of the hinge 20 and the temple 16 within the hinge 20 can be used for applying force to the securing 100 mechanism. More specifically, the rear edge 112 of the mechanism 100 can be positioned so that it will make contact with the forward edge 17 of the temple 16 when the temple is rotated to align the temple 16 with the end piece 18, as if the sunglasses were being prepared to be worn. Accordingly in FIG. 3, the position of the hinge 20 is shown as being located closer to the mechanism 100, which can accommodate this functionality. Therefore in this configuration, manual force by the user is required to unlock the securing mechanism by pulling the mechanism towards the right (according to the view of FIG. 3). However, a mechanical assist can be provided to move the mechanism to the locked position by simply rotating the corresponding temple so that the forward edge 17 of the temple contacts the rear edge 112 of the mechanism 100. Further, the forward edge 17 of the temple can be used to further assist in maintaining the mechanism 100 in the locked position by trapping or holding the rear edge 112 of the mechanism 100 against the forward edge 17.

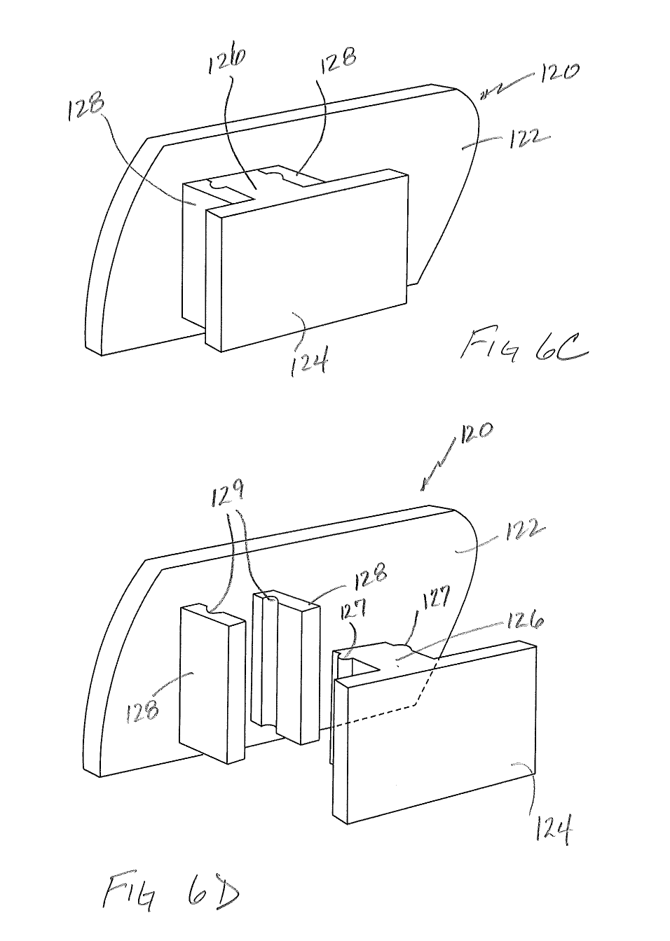

Referring to FIGS. 5, 5A, and 6A-6D, another embodiment of the present invention is provided. In this embodiment, the securing mechanism 120 includes a body 122 and a rear locking tab 124. The locking tab includes a post 126 that is frictionally received between guides 128. A “snap” fit can be achieved by providing the post with a slightly enlarged end 127 received in opposing grooves 129. The mechanism 122 is slidable within the opening 54 of the end piece 18, and is urged to a normally closed or locked position by a spring 130 mounted within a spring housing 132 integral with the end piece 18. FIG. 5A also illustrates that the end piece 18 may be formed with a channel 134, thereby reducing the degree to which the mechanism 120 protrudes from the exposed face of the end piece 18.

In the embodiment of FIG. 5, the front or forward edge 136 of the mechanism 120 engages a slot 138 formed in the facing surface of the lens 22 to hold the lens in place. This positional engagement configuration does not require the mechanism 120 to frictionally engage the lens 22, and the lens is rather held in place by the complementary shaped forward edge 136 and slot 138. Although the hinge 20 in FIG. 5 is shown as being separated from the mechanism 120, the hinge 20 can be located such that the forward edge 17 of the temple 16 can be used as mechanical assist to move the mechanism 120 towards the closed position, as described with respect to the embodiment of FIG. 3. Therefore, it should be understood that each of the embodiments disclosed herein can adopt the mechanical assist feature by locating the hinge 20 and forward edge 17 of the temple 16 near the securing mechanism.

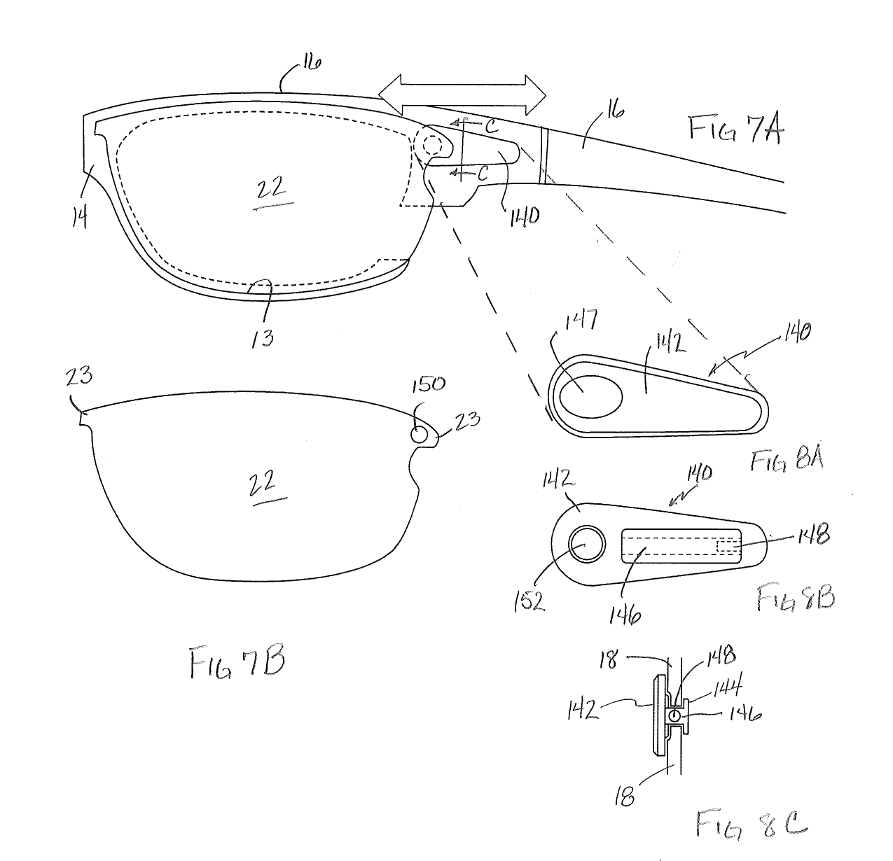

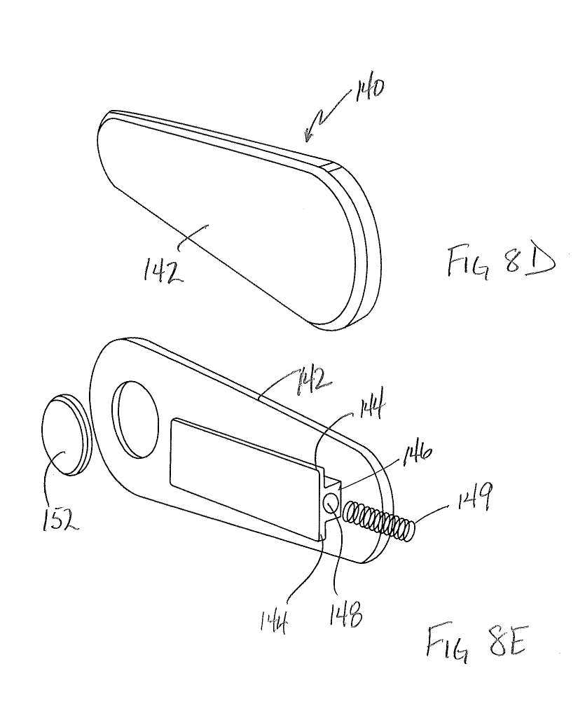

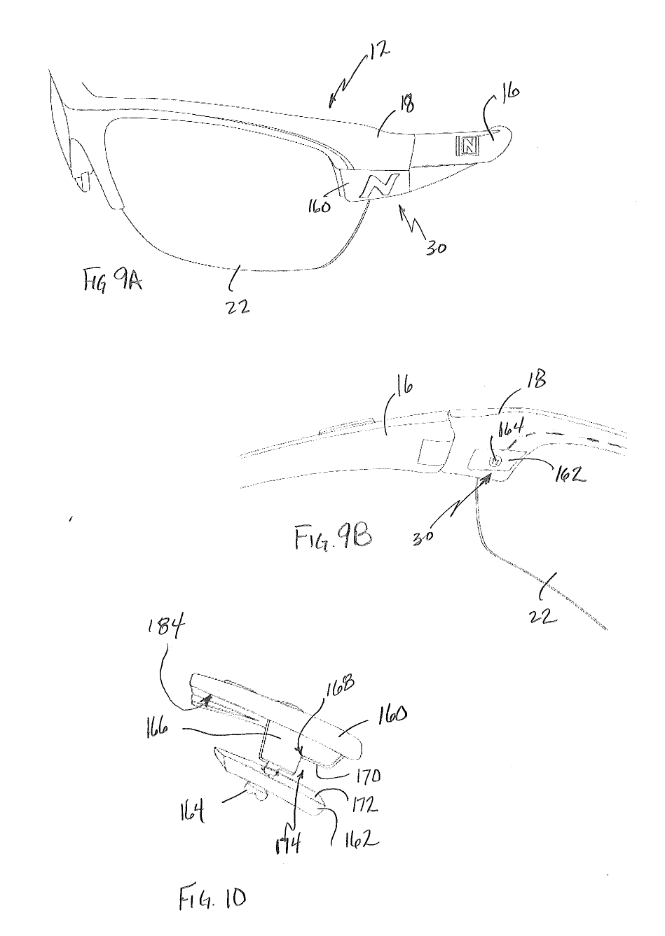

Referring to FIG. 7A, yet another embodiment is illustrated. In this embodiment, the securing mechanism 140 includes a body 142, a rear flange 144, and a web 146 that interconnects the body 142 and the flange 144. As shown best in FIG. 8C, the mechanism 140 is slidable within the opening 54 of the end piece 18, similar to the sliding capability of the mechanism in the other embodiments. In addition to the extensions 23 formed on the opposite side of the upper edge of the lens 22, the lens also may also include a magnet 150 that is used in conjunction with a magnet 152 attached to the mechanism 140 to assist in maintaining the mechanism in the closed position. More specifically, as best seen in FIG. 8B, the rear side of the mechanism 140 is illustrated in showing the magnet 152 mounted near the forward end of the mechanism 140. When the mechanism is advanced to its locked position by moving it to the left (according to the orientation of FIG. 7A), the magnet 152 aligns with the magnet 150 on the lens. The two magnets 150 and 152 provide a force for the mechanism 140 to remain in the locked position. The mechanism 140 may include an indentation 147 sized for receiving a thumb or finger of a user to assist in sliding the mechanism 140. This embodiment also includes a spring opening 148 formed on the end or trailing edge of the mechanism 144 for receiving a retaining spring 149, thereby urging the mechanism 142 toward the normally locked position.

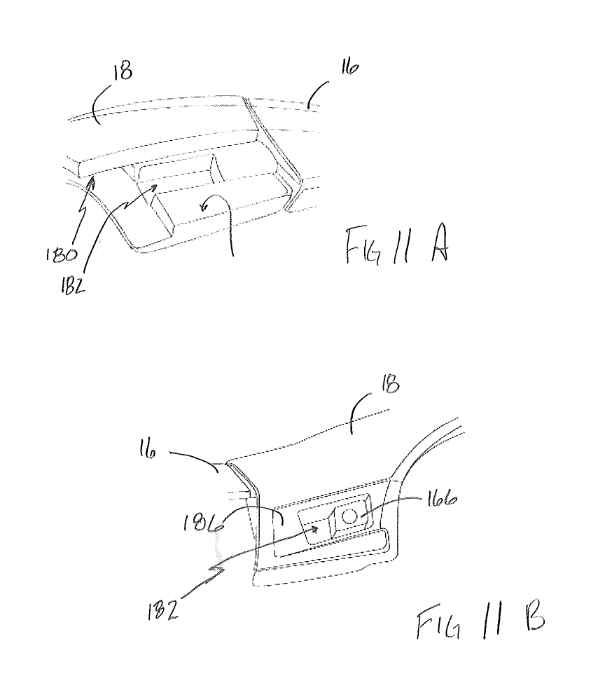

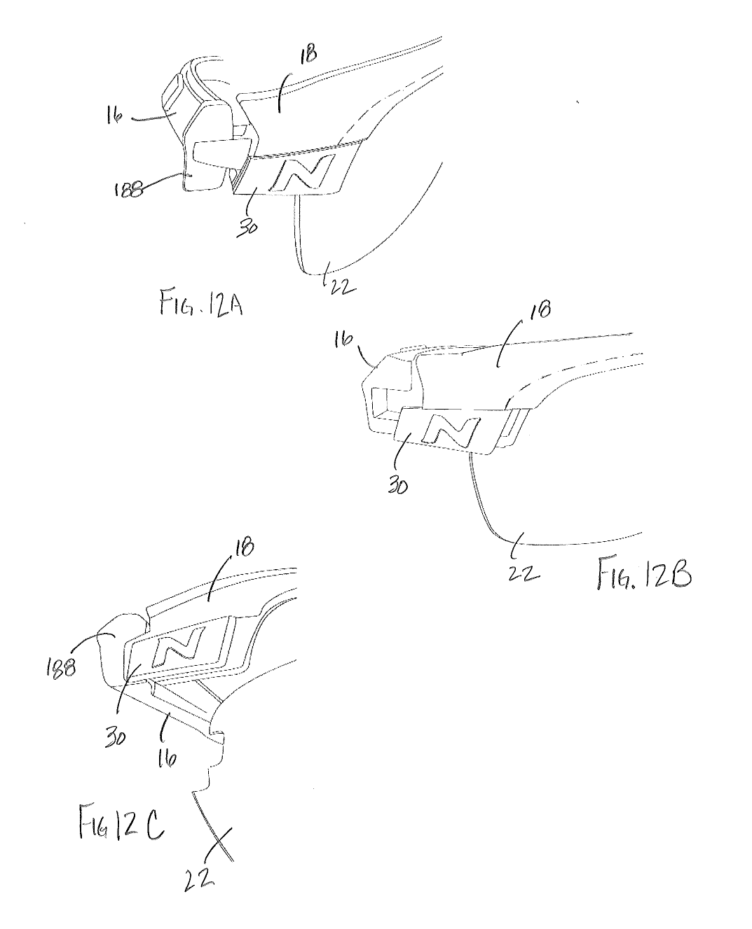

Referring to FIGS. 9A-13B, another embodiment is illustrated. More particularly, a securing mechanism 30 is shown from an exterior perspective in FIG. 9A and an interior perspective in FIG. 9B. The securing mechanism 30 is positioned on the end piece 18 of the frame 12. As illustrated, the securing mechanism 30 is utilized with separate or dual lenses 22. It should be appreciated that the securing mechanism 30 may also be used with a mono lens. The securing mechanism 30 is illustrated in FIG. 10. The securing mechanism 30 comprises an exterior panel 160 and a rear locking tab 162. For assembly purposes, these components are constructed separately and attached by a screw 164, although other means for connecting the two components are known to those of skill in the art. Branding information or other indicia, such as the letter “N” illustrated in FIG. 9A, may be part of the panel 160. As seen in FIG. 10, a web 166 also forms part of the securing mechanism 30 and further functions to interconnect the locking tab 162 in a spaced relation relative to the exterior panel 164. The web 166 includes a shoulder portion 168 having a first surface 170 that is generally parallel to the inside surface 172 of the locking tab 162. The surfaces 170 and 172 form a channel 174 to receive a perimeter edge portion of a lens 22.

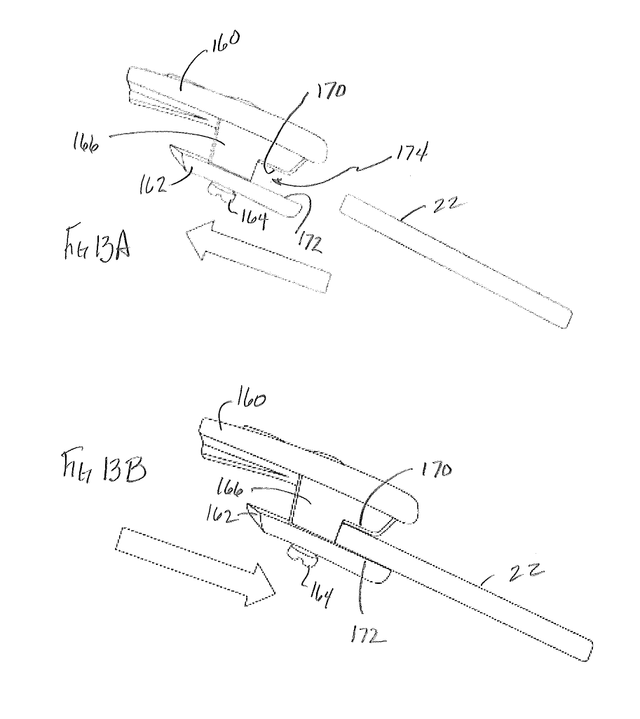

FIG. 12A shows an outside or exterior view of the end piece 18 of a frame, similar to that illustrated in FIG. 9A, but with the securing mechanism 30 removed. The frame forms a channel 180 that receives the upper perimeter edge of a lens 22. An aperture 182 is formed through the end piece 18. When the securing mechanism 30 is assembled, the web 166 is positioned within the aperture and moves back and forth between opposite ends of the aperture 182. The inner surface 184 of the outer panel 164 slides along surface 186 of the end piece 18. As illustrated in FIG. 12B, the outer panel 160 and web 166 are partially assembled in the end piece 18 with the rear locking tab 162 and screw 164 removed. The inner surface 172 of the locking tab 162 slides on surface 186.

An operational sequence for the securing mechanism 30 is shown in FIGS. 12A, B and C. In FIG. 12A, the securing mechanism 30 is in a locked position securing a lens 22 relative to a frame 12. In addition, the temple or ear stem 16 is shown in a folded or closed position. As illustrated, the hinge 20 and the planar end portion 188 are visible. When the ear stem 16 is in an open or unfolded position, the planar end portion 188 blocks movement of the securing mechanism 30. Turning to FIG. 12B, the securing mechanism has been moved to the left or unlocked position. As a result, the securing mechanism is detached from the lens 22. As shown in FIG. 12C, with the securing mechanism 30 in an unlocked position, the lens 22 may be detached from the frame 12. FIGS. 13A and 13B show the securing mechanism 30 and lens 22 in an unlocked state and locked state, respectively. In the locked state (FIG. 13B), the peripheral edge of the lens is engaged with and secured by the channel 174 formed between the surfaces 170 of the web 166 and surface 172 of the locking tab 162. To secure lens 22 to the frame 12, the lens 22 is first properly oriented and positioned within channel 180 of the frame 12. The securing mechanism may either be manually moved from an unlocked position to a locking position, or alternatively this may be accomplished by unfolding and opening the ear stem. In the latter context, the planar portion 188 abuts the end of the securing mechanism and pushes it into a locked position upon fully unfolding the ear stem 16.

In accordance with the present invention, various embodiments are provided for a securing mechanism used to releasably secure a lens within/against the frame of eyeglasses. The invention is adapted for any type of optical eyewear, but may be considered especially adapted for use in connection with removable sunglass lenses, which may be either prescription or nonprescription lenses. The mechanism enables a user to quickly and easily facilitate removal and replacement of lenses, without the need for tools. The removable lenses are not limited to any particular configuration, and therefore, the invention provides a versatile solution for replacement of lenses utilizing a single sunglass frame assembly. In addition and conversely, it is also contemplated that one or more sets of lenses may be switched between multiple frames. Thus, a user may have multiple frames for different purposes and/or occasions and may wish to utilize a single set of lenses with multiple frames or multiple sets of lenses with multiple frames.

The sunglasses construction of the present invention may incorporate a pair of securing mechanisms, one for each separately removable lens. Alternatively, the invention may incorporate a single securing mechanism for a mono-lens configuration.

What is claimed is:

1. Eyeglasses with removable lenses, comprising:
An eyeglasses frame including a pair of eyeglass frame members for holding respective lenses, a bridge interconnecting the frame members, each of the frame members including respective frame end pieces, and a pair of temples hingedly connected to corresponding end pieces; and
a securing mechanism secured to one of the end pieces, said securing mechanism including a portion thereof for engaging a facing surface of a corresponding lens, and said securing mechanism being slidable between a locked position for holding the lens against the frame, and an unlocked position in which the securing mechanism is moved away from the facing surface of the lens.

2. Eyeglasses, as claimed in claim 1, wherein:
said securing mechanism includes a catch for engaging a hook formed on the facing surface of the lens.

3. Eyeglasses, as claimed in claim 1, wherein:
said securing mechanism is slidable in a substantially horizontal orientation as the eyeglasses are oriented for wear by a user, said securing mechanism being slid towards the corresponding lens for locking the securing mechanism, and said securing mechanism being slid away from the corresponding lens for unlocking the securing mechanism.

4. Eyeglasses, as claimed in claim 1, wherein:
said securing mechanism includes a tongue formed on an end of the securing mechanism, said tongue being placed within a corresponding groove formed on the facing surface of the lens for locking the securing mechanism.

5. Eyeglasses, as claimed in claim 1, wherein:
said securing mechanism includes a forward edge thereof placed within a corresponding slot formed on the facing edge of the lens for locking the securing mechanism.

6. Eyeglasses, as claimed in claim 1, wherein:
said securing mechanism includes a first portion residing on a front surface of the end piece, and a second portion residing on a back surface of the end piece.

7. Eyeglasses, as claimed in claim 1, wherein:
said securing mechanism includes a first magnet mounted thereon, and said lens includes a second magnet mounted thereon, wherein when said securing mechanism is moved to the locked position, the first and second magnets align with one another.

8. A securing mechanism especially adapted for use with eyeglasses in order to secure lenses of the sunglasses to a frame of the sunglasses, said mechanism comprising:
a body secured to an end piece of the frame, said body including a portion thereof for engaging a facing surface of a corresponding lens, and said securing mechanism being slidable between a locked position for holding the lens against the frame, and an unlocked position in which the securing mechanism is moved away from the facing surface of the lens;
an element formed on said body for holding the body against the lens, said element including at least one of a friction engaging member for frictionally engaging the lens, a magnetic member for magnetically engaging the lens, or a combination of the friction engaging member and magnetic member.

9. A method of removing and replacing lenses in eyeglasses, said method comprising:
providing: (i) a frame including a pair of frame members for holding respective lenses, (ii) a bridge interconnecting the frame members, each of the frame members including respective frame end pieces, (iii) a pair of temples hingedly connected to corresponding end pieces (iv) a securing mechanism secured to one of the end pieces, said securing mechanism including a portion thereof for engaging a facing surface of a corresponding lens, said securing mechanism being slidable between a locked position for holding the lens against the frame, and an unlocked position in which the securing mechanism is moved away from the facing surface of the lens;
grasping the securing mechanism and sliding the mechanism from the locked to the unlocked position;
removing the lens from the frame;
obtaining a replacement lens and placing the lens in engagement with features on the frame for retaining the replacement lens: and
grasping the securing mechanism and sliding the mechanism from the unlocked to the locked position in order to secure the replacement lens in the frame.
